(19) United States
(12) Patent Application Publication
(10) Pub. No.: US 2012/0137202 A1
(43) Pub. Date: May 31, 2012

(54) SYSTEM FOR EXPLORING CONNECTIONS BETWEEN DATA PAGES

(76) Inventor: Theodor Holm Nelson, Long Valley, NJ (US)

(21) Appl. No.: 13/367,250

(22) Filed: Feb. 6, 2012

Related U.S. Application Data
(63) Continuation-in-part of application No. 12/039,656, filed on Feb. 28, 2008, now abandoned.

(51) Int. Cl. G06F 17/00

(52) U.S. Cl. 715/205

(57) ABSTRACT

A system to explore connections between a current and other pages by stepping through and seeing connections by successive juxtaposition. Content links each represent a connection between a first and second pages, where such content links each include at least one departure point in the first page and arrival point in the second page. A current content link exists between a current (first) page and a companion (second) page. At least part of the current page including the current content link's departure point and at least part of the companion page including the current content link's arrival point, are shown spatially isolated in a display visually emphasizing the current content link.

### CROSS-REFERENCE TO RELATED APPLICATIONS

This is a continuation-in-part of U.S. patent application Ser. No. 12/039,656, filed Feb. 28, 2008 and hereby incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Technical Field

The present invention relates generally to data processing, and more particularly to an operator interface with which a user can explore connections linking data pages.

2. Background Art

In data there are potentially vast numbers of connections that might be made, either by humans or by automatic processes. This leads to a problem for those who need to appreciate, work with, study, etc., such connections. Basically, since vision is our primary human sense, we would like to be able to visualize the connections between data.

Documents written by human authors are one very common example of such data. For instance, a legal ruling by a court may be cited, quoted, or remarked on in other legal rulings, newspapers, textbooks, correspondence, etc. Citation back to an original document in another document entails a connection between the documents, specifically one identifying the location of all, a single part, or multiple parts of the original. Similarly, quotation entails an obvious connection between two documents, albeit one that may be hard for humans to see but that can easily be verified with a computerized process. And remarks can be of many types, such as a paraphrase, a rebuttal, a concurrence, an argument by analogy, etc.

Written documents are a particularly useful example to help appreciate the potential vastness of the problem of connection visualization. Thousands of documents may have connections to a single major legal ruling. But that legal ruling may, in turn, have connections to many preceding legal rulings, to transcripts of testimony or legislative debate, etc. In fact, turning to a new example, the number of connections to and even between major religious documents like the Rigveda, Diamond Sutra, Talmud, Bible, Koran, etc. numbers well into the millions and increases on a daily basis.

Other types of data are subject to the same problem of visualizing connections. For instance, connections can be made between images such as maps, aerial photographs, timelines, portraits, comics, etc. Connections can also be made between visual representations of sound, such as signal graphs, spectral plots, etc. Of course, connections can be made between different types of data, e.g., between a map of Europe and a novel like War and Peace. Thus, while written documents are used primarily herein as examples, the scope of the problem and solution about to be presented should not be interpreted too narrowly.

For present purposes, a connection between two sets of data can be generalized as having a type, one or more locations in the first data set, and one or more locations in the second data set. Furthermore, since the present goal is visual presentation of connections and automated (e.g., computerized) processes to facilitate that, the term “data” itself is awkward and the term “page” is now used herein. Rather than “page” as a page in a document, however, the inventor here means “page” as that term is used in the computer arts to mean a body of data that is worked with or worked on.

Of course, human kind has long struggled with the problem of connection visualization. Detailing pre-computer approaches is beyond the scope of this or probably any document. Until now, the state of the art in computer approaches has entailed hypertext designs, such as HyperCard™ and the World Wide Web. These approaches, however, have generally reduced the allowed number of connections and only allowed ones that are of non-overlapping sections of the content. This is undesirably limiting. For example, again using a legal ruling, one lawyer may want to comment on paragraph A, another on paragraphs A and B together, and yet others may comment only on individual sentences in A and B. This kind of overlap cannot be represented in today's popular hypertext based systems because the designers of these could not find any way to clarify or visualize such a tangle.

Accordingly, improved systems to explore connections between data are still needed, and it is desirable that such systems facilitate visualizing such connections.

### BRIEF SUMMARY OF THE INVENTION

Accordingly, it is an object of the present invention to provide a better way to explore connections between data pages.

Briefly, one preferred embodiment of the present invention is a method for a user to explore relationships between data in a plurality of pages. A current page is chosen from among the plurality of pages. Then one or more connections each representing an one of the relationships are determined, wherein each connection has at least one departure location in a page and at least one arrival location in a page. With respect to the current page, a current connection is then chosen from among the one or more connections that were determined. A current departure location and a a current arrival location of the current connection are then chosen. In a display, at least a portion of the page that includes the current departure location is presented spatially isolated as a first page segment, at least a portion of the page that includes the current arrival location is presented spatially isolated as a second page segment, and the current departure and arrival locations are presented as visually connected. A user selection is then accepted of a content link in the display, to be a selected link. This selected link accordingly has a selected departure location and a selected arrival location, and these become a new current arrival location and a new current departure location for presentation I the display, thereby step-wise navigating the pages to swing the user's focus to the current departure location along with its relationship to the current arrival location.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 is a direct frontal screen capture that particularly shows a current page, a companion page, and a current connection between these in an embodiment of the connection visualization system (CVS) that is implemented in computer software running on computer hardware.

FIG. 2 is also a direct frontal screen capture, but a more distally removed one showing all of the pages as they are arranged in a three dimensional (3D) space by the embodiment of the CVS in FIG. 1.

FIG. 3 is a right-side and forward-looking screen capture showing all of the eleven pages of the CVS in FIGS. 1-2.

FIG. 4 is again a direct frontal screen capture of the same current page and the companion page in FIG. 1, only taken even closer in.

FIG. 5 a direct frontal screen capture after a navigation operation, showing how the current page is moved so that the new current connection is shown centrally and a different page that the new current connection connects to is now the companion page.

FIGS. 6A-C are a listing of the edit decision list used by the CVS for the example shown in FIGS. 1-5.

FIG. 7 is a flowchart depicting a routine which is usable by the CVS to find corner-points of spans, and thus to permit connections (transclusions and flinks) to be properly depicted with respective pages in the display.

FIGS. 8a-b show a first span and a second span viewed in either of two useful manners.

FIG. 9a shows a beam representing a connection in a “simple” context, and FIG. 9b shows beams representing connections in a slightly more complex context.

In the various figures of the drawings, like references are used to denote like or similar elements or steps.

### DETAILED DESCRIPTION OF THE INVENTION

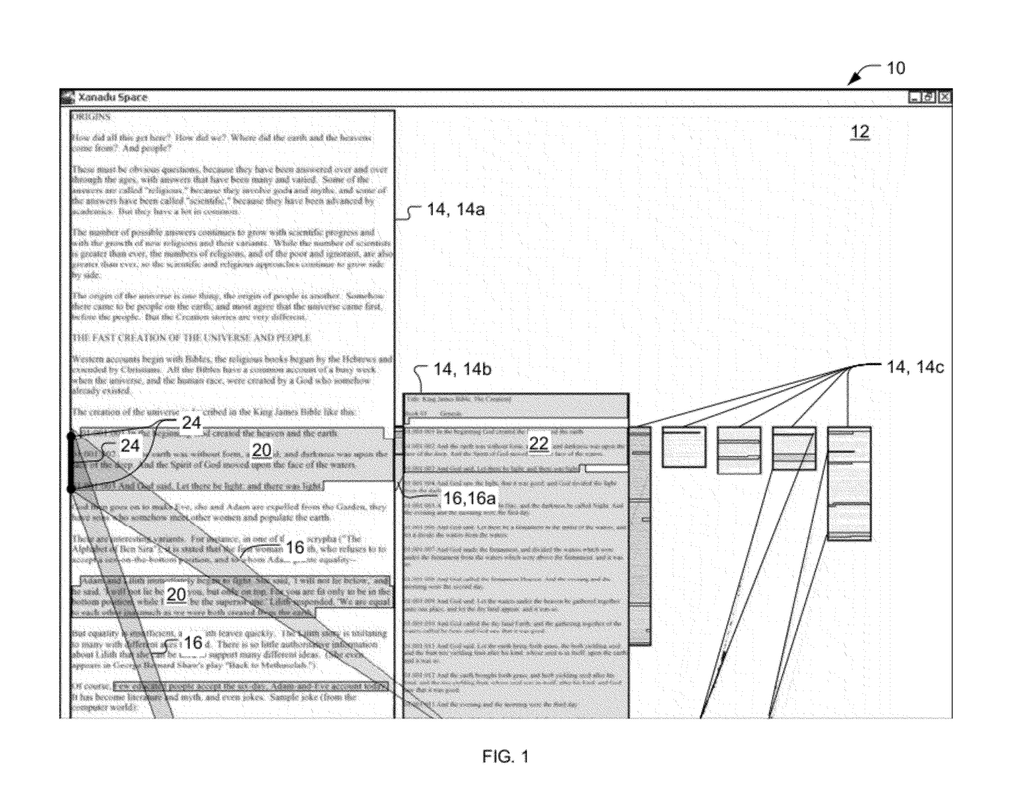

A preferred embodiment of the present invention is a system to visually explore connections between data pages. As illustrated in the various drawings herein, and particularly in the views of FIGS. 1-5, preferred embodiments of the invention are depicted by the general reference character 10.

FIGS. 1-5 are screen captures taken from an embodiment of the connection visualization system (CVS 10) that is implemented in computer software running on computer hardware. In this series of figures the CVS 10 is using a display 12 to present eleven pages 14, including a current page 14a, a companion page 14b, and multiple background pages 14c.

The pages 14 here each are of written documents, including: (1) BenSiraLilith-cut.txt, an excerpt from Apocryphon, The Alphabet of Ben Sira; (2) DarwinDescentCh1-cut.txt, an excerpt from The Descent Of Man, Chapter 1, by Charles Darwin; (3) DeadOfNightRev-cut.txt, an excerpt from a review by britishhorrorfilms.co.uk of the 1945 film Dead of Night; (4) GilgamishFlood-cut.txt, an excerpt from the Gilgamish Epic, The Flood; (5) K.JamesCreation-cut.txt, an excerpt from the King James Bible, The Creation; (6) K.JamesFlood-cut.txt, an excerpt from the King James Bible, The Flood; (7) LongBibleOrigins-cut.txt, an excerpt from A History of Composition and Interpretation, by Dr. Thomas L. Long; (8) NelsonIntro.txt, an introductory document written by the present inventor to relate to the other documents for the sake of this example; (9) SchoolsBigBang-cut-FIX2.txt, an excerpt from The Big Bang Theory, from SchoolsObservatory.org.uk; (10) SchoolsSteadyState-cut.txt, an excerpt from The Steady-State Theory, also from SchoolsObservatory.org.uk; and (11) WpediaSteadyState-cut.txt, an excerpt from Steady-state Theory, as found in Wikipedia™. In FIG. 1 the current page 14a shows part of the NelsonIntro.txt document and the companion page 14b shows part of the K.JamesCreation-cut.txt document.

In the series of figures in FIGS. 1-5 the CVS 10 also uses the display 12 to present twenty-nine connections 16 between the various pages 14, including a current connection 16a. The connections 16 in this embodiment of the CVS 10 can be characterized as either transclusions or flinks. Generally, the connections 16 are content links, that is, linkages between portions of the content in a first page 14 and a second page 14.

Digressing briefly, the following discussion is of the inventor's presently preferred embodiment of the CVS 10, and thus is of a complex and more fully-featured embodiment. However, simpler embodiments are certainly also possible. For instance, an earlier embodiment employs content links in hypertext markup language (HTML) that represent connections between documents in HTML.

Continuing, a transclusion is a connection 16 where the content is the same in each page 14. Since computers are particularly good at matching, transclusions can be connections that are made automatically. [Please note, the present inventor has written extensively on transliterature and on transclusion as a tool to facilitate achieving that. For present purposes it should simply be appreciated that transclusion in the present context is defined as just stated. In the context of transliterature narrower definitions are often employed. Additional discussion and a reference for those interested is provided below.]

A flink, or floating link, is a connection 16 that is imposed on the contents of two pages 14. Unlike HTML links, which are embedded, flinks are conceptually much like postage stamps at their ends, with a geometric device connecting those ends. Flinks may assume different types, may be applied in any quantity, can fully or partially overlap, and can overlap transclusions.

FIGS. 1-5 are in black and white, and appear somewhat in greyscale, so they do not well represent the natures of the various connections 16. In the inventor's presently preferred embodiment of the CVS 10 the current connection 16a is highlighted, connections 16 that are transclusions are shown in one color and connections 16 that are flinks are shown in another color. Although not implemented in the embodiment in FIGS. 1-5, connections 16 that are different types of flinks can be shown in different colors. For example, a connection that is of type “bookmark” could be shown in transparent blue, a connection that is of type “resemblance” could be shown in transparent green, a connection that is of type “clash” could be shown in transparent yellow, etc.

Turning now to FIGS. 1-5 individually, FIG. 1 is a direct frontal view that particularly shows the current page 14a, the companion page 14b, and the current connection 16a between these. The current connection 16a is highlighted and is a transclusion (both aspects that do not show well in the black and white figure here). As can be seen clearly, however, the current connection 16a has distinct from- and to-locations in the pages 14.

Generalizing, a connection 16 has one or more from-locations in a first page 14, collectively termed a departure location 20, and a connection 16 also has one or more to-locations in a second page 14, collectively termed an arrival location 22. In FIG. 1 the current connection 16a has a departure location 20 that includes only one from-location (six lines of text) in the current page 14a and an arrival location 22 that includes only one to-location in the companion page 14b.

Coincidentally, there are two other connections 16 that overlap the current connection 16a in the current page 14a but that connect to other (background) pages 14. Even though the current page 14a and the companion page 14b are presented as spatially distinct in the foreground, “in front of” the background pages 14c, in this embodiment of the CVS 10 all in-frame connections 16 are shown in the foreground as a mater of design choice. This allows users to readily see that other connections 16 also exist and have relevance to the viewable portions of the current page 14a and the companion page 14b.

Continuing with FIG. 1, it can particularly be seen here that the connections 16 are represented as rectangular appearing regions or beams. The use of another visual mechanism is also possible, but a beam is a particularly useful way to depict connections 16 in pages 14 that represent many kinds of data, including text documents such as those in the example here.

When a connection 16 is between individual minimum units of data in two pages 14, a line can be used to represent the connection 16 in the display 12, and respective endpoints can be used for generating such a line. This is a minimal or degenerate case. Another case is where there is a connection 16 between an individual minimum unit of data in one page 14 and a non-minimal, contiguous unit of data, i.e., a “span” in another page 14 (an example of such a span 24 is emphasized in FIG. 1). A triangular region can then be used to represent the connection 16 in the display 12, and three corner-points can be used for generating such a region. And yet another case is where there is a connection 16 between a non-minimal, contiguous unit of data in one page 14 and a non-minimal, contiguous unit of data in another page 14. A rectangular region can then be used to represent the connection 16 in the display 12, and respective four corner-points can be used for generating such a region (examples of such corner-points 26 are also emphasized in FIG. 1).

Keeping in mind that the goal here is to generate regions on the display 12 to represent the connections 16, the inventor has chosen to use the addresses of “corner-points” of spans. If the corner-points of a span are the same, it follows that a line or a triangle is to be displayed. If the corner-points of a span are different, it follows that a triangle or a quadrilateral (a rectangle but not limited to right angles) is to be displayed. And if the corner-points of both spans are different, a rectangle is to be displayed. Ultimately, using a single pixel (or equivalent) is not particularly noticeable or informative in most modern displays, so showing rectangular beams serves best to depict the connections 16, as in the example in FIGS. 1-5. The subjects of corner-points, beams, regions, and display rendering are discussed further, presently.

Before continuing, however, it should be noted that the cases discussed above employed two different pages 14. Connections 16 that depart and arrive at different locations in a same page 14 are only slightly more complex conceptually, and essentially need not add any appreciable burden to implementing and employing embodiments of the CVS 10.

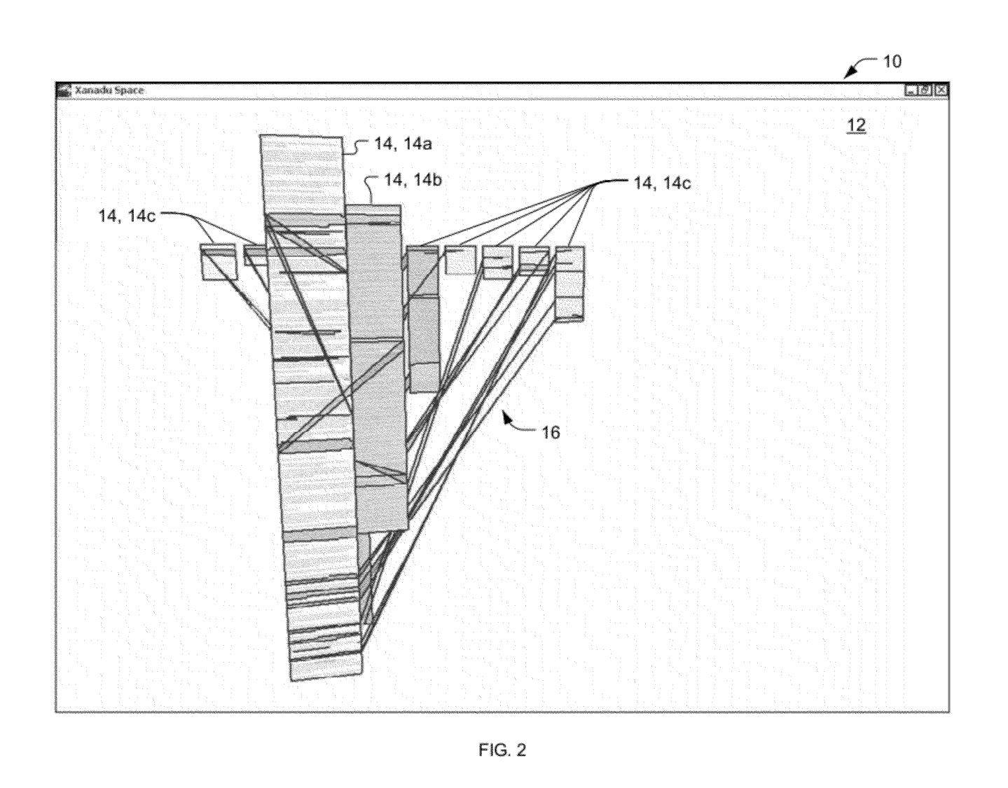

FIG. 2 is also a direct frontal view, but a more distally removed one showing all of the pages 14 as they are arranged in a three dimensional (3D) space by this embodiment of the CVS 10. Other embodiments of the inventive CVS 10 can use as few as two dimensions (2D). Here in FIG. 2 the relationships between the pages 14 and the connections 16 are viewable at a macro level without specific micro level content detail. (Various generally conventional “navigation” schemes and computer devices can be used to move in a 2D or 3D space. In the present embodiment, computer keyboard up and down arrow keys direct zooming in and out, left and right arrow keys direct movement in those directions, and right-click and drag computer mouse control directs the viewing angle.)

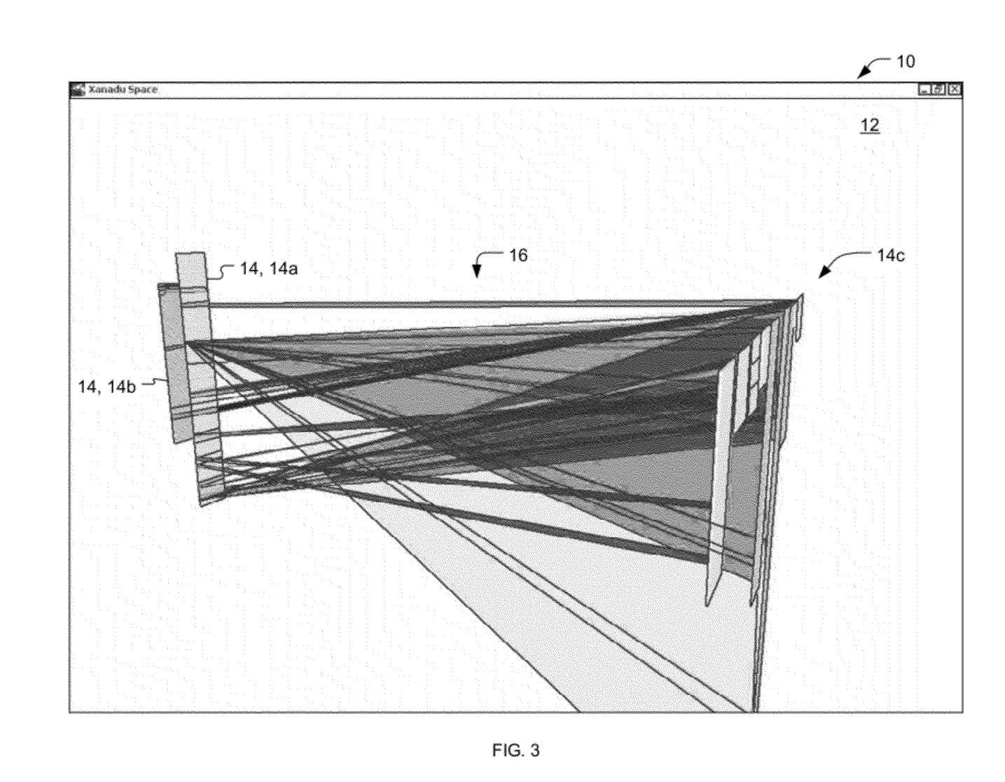

FIG. 3 is a right-side and forward-looking view showing all of the eleven pages 14. The current page 14a and the companion page 14b are to the left in this view. The connections 16 (other than the current connection 16a and other connections 16 between the current page 14a and the companion page 14b) are particularly visible in this view.

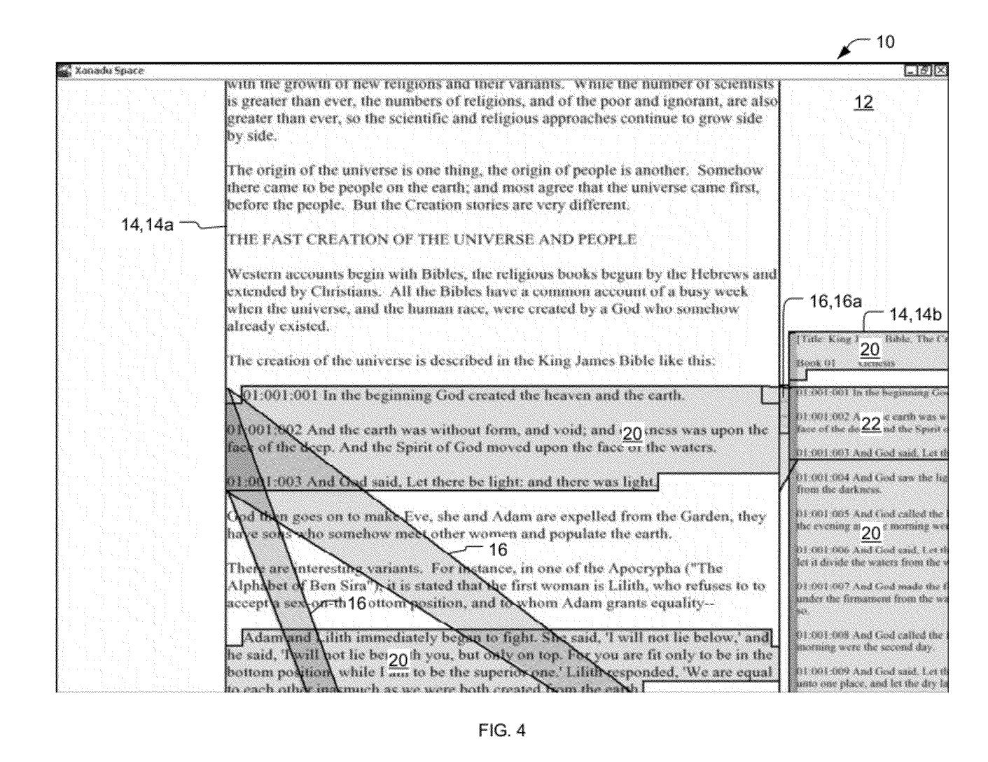

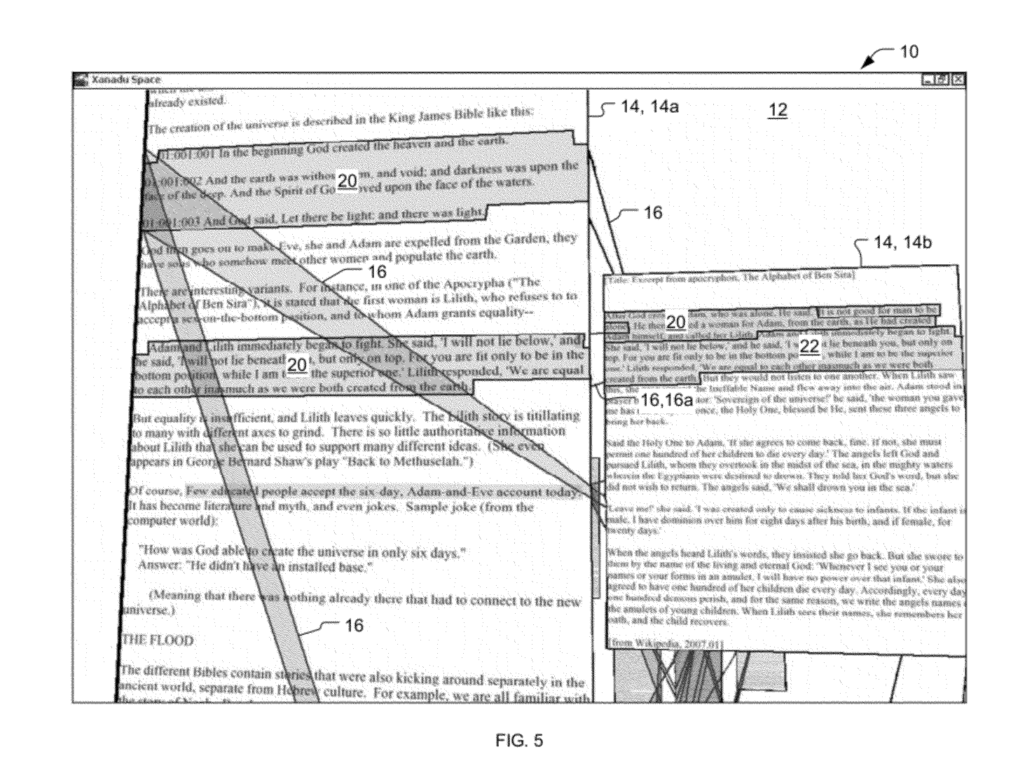

FIG. 4 is again a direct frontal view of the same current page 14a and the companion page 14b in FIG. 1, only taken even closer in. It can readily be seen here that the current connection 16a is a transclusion. Below the current connection 16a in the current page 14a is another connection 16. By making this connection 16 the current connection 16a, the view in FIG. 5 is made to appear.

In FIG. 5 the current page 14a is moved so that the new current connection 16a is shown centrally, and the page that the current connection 16a connects to is now shown as the companion page 14b. (Again, various generally conventional “navigation” schemes and computer devices can be used to move “along” the connections 16 in the multi-dimensional space between the pages 14. In the present embodiment, the computer keyboard “c” and “e” keys direct making the next downward or upward connection 16 in the current page 14a be the new current connection 16a. The computer keyboard “f” key directs making the companion page 14b the new current page 14a, and the computer keyboard “s” key directs making the current page 14a the new companion page 14b.)

The present inventor employs the term “swooping” to identify the act of swinging between the views of pages 14 in the manner just discussed, and the term “sworfing” (swooping plus morphing) to identify the act of zooming and out in viewing the pages 14. In novel and particularly useful manners, the CVS 10 permits navigation of the connections 16 between pages 14 to visually bring pages 14 and the particular data within them that is of interest, with the natures of the particular connections 16 Minks or transclusions) readily apparent. The views in FIGS. 1, 4, and 5 comparatively illustrates examples of swooping and sworfing.

Summarizing, it can now be appreciated that the inventive CVS 10 is useful for the side-by-side viewing, allowing the user to step, swoop, and sworf through the pages 14 and see the connections 16 by successive juxtaposition of pages 14 and exploring successive connections 16 in detail. The present current page 14a and a present companion page 14b are spatially isolated in a foreground area (or a reading plane) in the display 12, and the user is allowed to select any connection 16 in that current page 14a to be a current connection 16a that can be followed. The user may step to the next connection 16 in the current page 14a, or back to a previous connection 16 in the current page 14a. Alternately, the user may step sideways into the companion page 14b, making it the new current page 14a (but still holding the same connection 16 as the current connection 16a until the user chooses otherwise), or the user may step back. Conceptually, the following of connections 16 can be thought of as crossing bridges between the pages 14, from a departure location 20 in one page 14 to an arrival location 22 in another page 14. All of this provides for one-by-one detailed investigation of any connections 16 in a potentially huge hypertext complex of many pages 14.

The inventor's presently preferred embodiment of the CVS 10 employs a number of his previously developed technologies. For example, this embodiment of the CVS 10 uses ZigZag™ as its internal data structure. Portions of ZigZag as it currently exists are the subject of U.S. Pat. No. 6,262,736, issued Jul. 17, 2001 to the present inventor and titled “Interactive Connection, Viewing, And Maneuvering System For Complex Data.” Other portions are the subject of pending U.S. patent application Ser. No. 10/906,651, filed Feb. 28, 2005, also by the present inventor and titled “System For Combining Datasets And Information Structures By Intercalation.” Considerable more about ZigZag, authored by the present inventor and by others, can be found on the World Wide Web.

All data, meaning lists, tables, parameters, arguments, etc., are kept in one unified ZigZag structure as an inseparable conglomerate of zzcells, connected along different dimensions. All of the data structures are then automatically tied together by ZigZag, which manages all data changes so that data management is no longer a matter of assembling data components with programs and “glue.” Everything is automatically connected according to the way a ZigZag programmer sets things up.

Overall, this embodiment of the CVS 10 employs a graphics engine written in C++ and OpenGL, which interprets certain ZigZag lists (zzlists) as graphical presentations. By using C++, this engine is able to interpret and manage the zzlists at great speed. Many of the setup programs and less rapid routines are written in the popular scripting language Python. For example, the pages 14 and the connections 16 are mostly managed by such scripts written in Python.

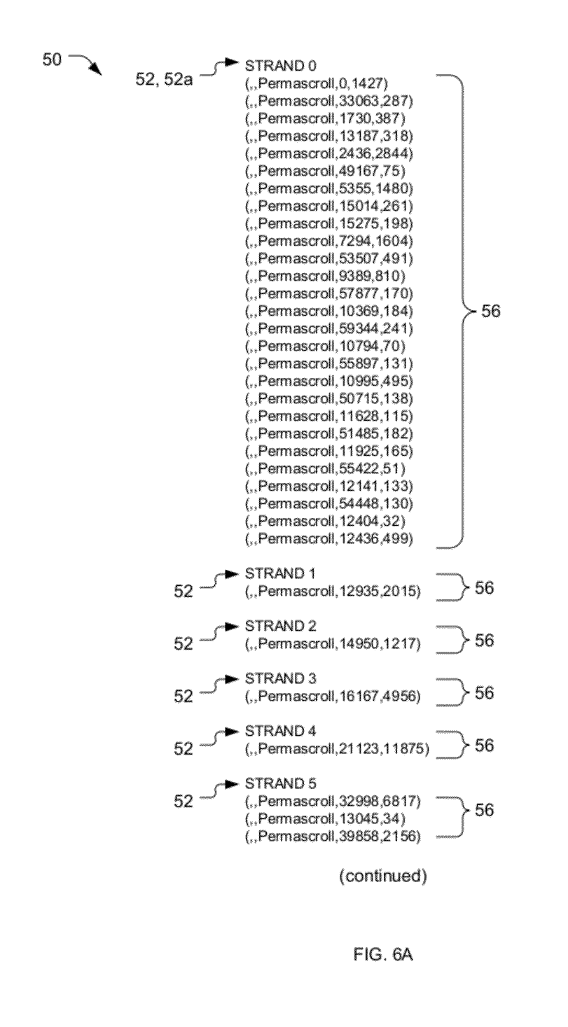

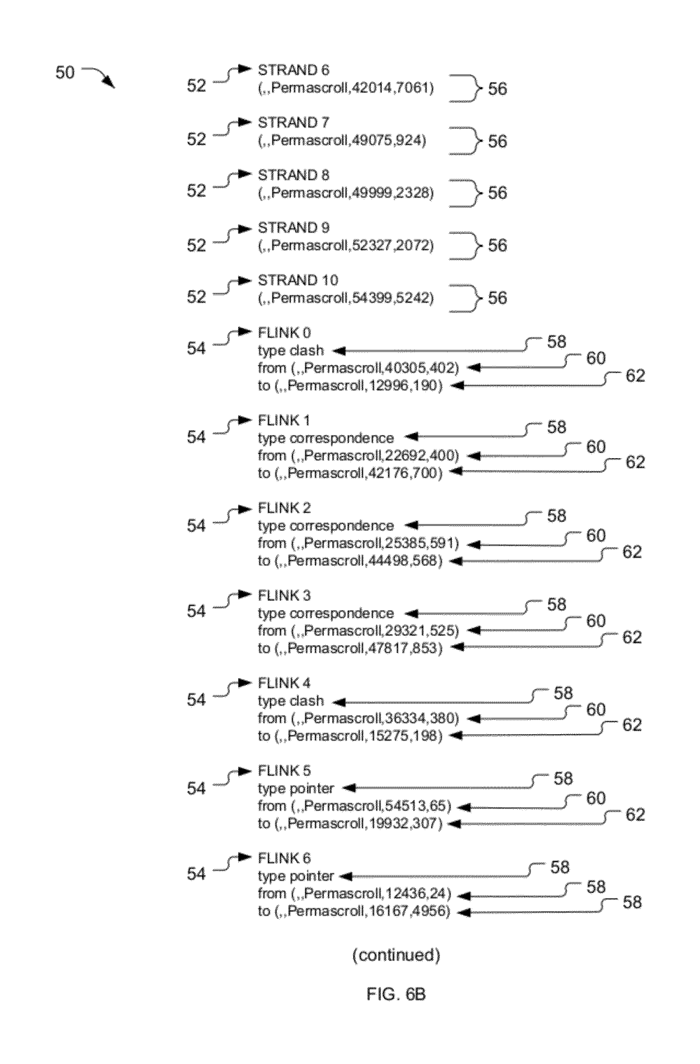

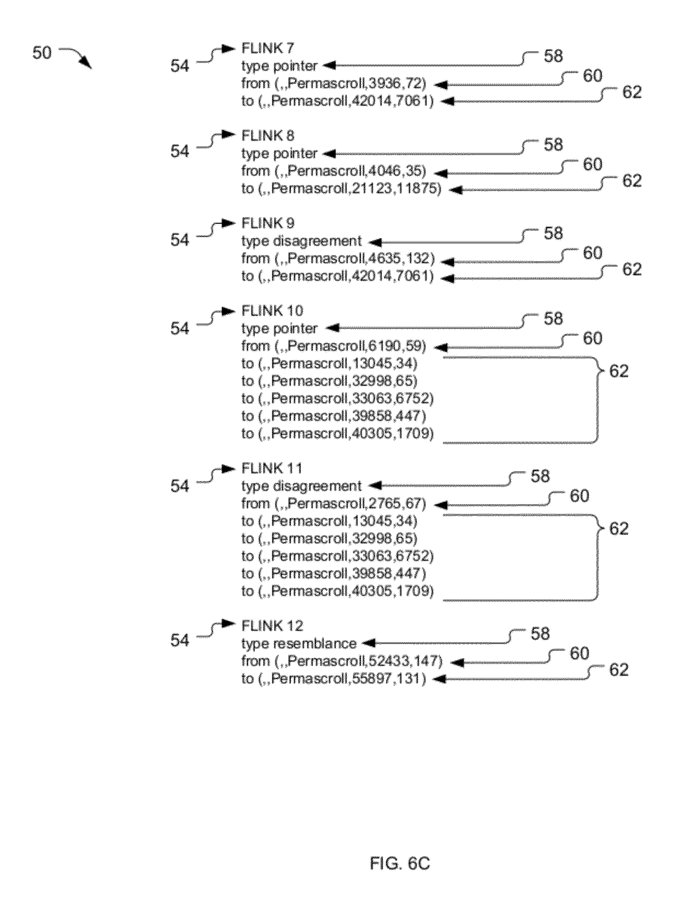

The primary input to this embodiment of the CVS 10 is an edit decision list, and copies of the data sets (i.e., what is or will be used to generate the pages 14). FIGS. 6A-C are a listing of the edit decision list 50 used by the CVS 10 for the example shown in FIGS. 1-5. Each of the eleven pages 14 is represented by a strand entry 52 (numbered 0 through 10 here). The connections 16 that are flinks are each represented by a flink entry 54 (numbered 0 through 12 here). The connections 16 that are transclusions are not represented in the edit decision list 50, i.e., there is no transclusion entry element, since transclusion are discovered automatically. Having the CVS 10 automatically identify transclusions as connections 16, the identity of content is always verified. Note also here that a flink entry 54 for a flink type connection 16 can indicate that the data at a departure location 20 and an arrival location 22 is identical.

Taking the strand entry 52 labeled “STRAND 0” as an example (hereinafter strand entry 52a when referred to specifically), this has 27 strand content entries 56 that each specify data that will be incorporated into the page 14 corresponding with STRAND 0. Coincidentally, this page 14 will initially be the current page 14a when the CVS 10 starts. It should be noted, however, that the page 14 corresponding with STRAND 1 will not necessarily be the initial companion page 14b. That will be determined by the first connection 16 occurring in the current page 14a.

The strand content entries 56 here have five comma-delimited fields: global location, local location, file identifier, starting position, and size.

The global location specifies where a file containing data for use in a page 14 can be found in a global scheme in which the inventive CVS 10 is employed. Explicitly specifying a global location is optional. When explicitly specified, however, various systems can be used. For example, a URL can specify a location on the Internet or another scheme can be used to identify a specific system in a local area network. In the case depicted in FIG. 6A, the omission of a global location signifies that the data is local, or is in a preconfigured default location.

Similarly, the local location specifies where a file containing data for use in a page 14 can be found in a local scheme in which the inventive CVS 10 is employed. Explicitly specifying a local location is also optional and, when done, various systems can also be used. For example, a drive and path can be provided to specify a location in a specific computerized system. In the case depicted in FIG. 6A, the omission of a local location signifies that the data is in the same place as the edit decision list 50, or is in a preconfigured default location.

The file identifier could also be made optional, albeit limiting such an embodiment of the CVS 10 significantly. It is not anticipated that this will be done often. In the cases depicted in FIG. 6A-C, the data is all contained in a single file titled “Permascroll.txt.” The eleven actual source documents (listed previously herein) were simply all concatenated together to make this one text file. This is not a requirement of the CVS 10, and frequently this will not be done, but it is useful for various operational reasons. For example, it permits the CVS 10 to display pages 14 rapidly. In sophisticated embodiments of the CVS 10, especially when working with large numbers of pages 14 that are dispersed widely, this also ensures that needed data will be available whenever a user follows a connection 16 to it. Of course, other file formats than simply “*.txt.” can also be used, but it is anticipated that “*.txt” will be the typical default format in many embodiments or configurations of the CVS 10.

The starting position and size fields are straightforward. They specify where a block of data begins in a file and the extent of it. For example, the first strand content entry 56 in strand entry 52a specifies 1,427 characters of data beginning in the first (0-indexed) position in the Permascroll.txt file. The second strand content entry 56 in strand entry 52a specifies 287 characters of data beginning at the 33,063-th character position into the Permascroll.txt file.

In passing, it can be appreciated that strand entry 52a (and also the strand entry 52 for STRAND 5) direct complex (that is, multi-block) instances of transclusion as defined in the transliterature context. The page 14 that is generated based on strand entry 52a is built with a transclusion operation from 27 portions of a single source document (although this could also easily be done from single portions of 27 source documents, etc.). Although not further germane here, a more detailed discussion of transclusion and transliterature can be found in “Transliterature, A Humanist Design” at the transliterature.org web site.

Continuing, the flink entries 54 each includes a type entry 58, one or more from-location entries 60, and one or more to-location entries 62. The type entry 58 is conceptually straightforward in nature, although the potential range of types can encompass virtually any manner in which data can be classified. The from-location entry 60 and the to-location entry 62 specify locations the same way that a strand content entry 56 does, with five similar comma-delimited fields for global location, local location, file identifier, starting position, and size.

Other than strand entry 52a being the first, the order of the other strand entries 52 in an edit decision list 50 is not particularly relevant to use of the CVS 10. In the presently preferred embodiment this merely determines the left to right ordering of the pages 14 when they are background pages 14c. The current page 14a is initially determined based on the first strand entry 52a, the companion page 14b is determined based on which page 14 the current connection 16a points to, and the current connection 16a is initially determined based on it being the connection 16 that occurs first in the current page 14a.

The order of the flink entries 54 also has little relevance to use of the CVS 10. In FIG. 1 three connections 16 have the same departure location 20. As a matter of design choice in this embodiment of the CVS 10, transclusions are not allowed to overlap. In the case of a potential multi-way contention to be the current connection 16a, like the three-way situation we see here, this facilitates using a rule that a transclusion “trumps” a flink, thus making the transclusion type connection 16 the current connection 16a here. (Actually, the idea is that in an overlap they are sequentially stepped through. If a flink and a transclusion have the same endset, one is to be chosen first (typically the transclusion) and the other is chosen second.) As for when there is contention only between flinks having identical departure locations 20, using the first specified in a flink entry 54 is the rule that is applied here (of course, as a mater of mere design choice, other rules can be used instead).

It should be noted that a flink entry 54 may have one or more from-location entries 60 or to-location entries 62 that do not resolve to any location in any present page 14. For that matter, a flink entry 54 can even have all of its from-location entries 60 not presently resolvable, or all of its to-location entries 62 not presently resolvable, or simply all of both of these not be presently resolvable. As a matter of design choice this can be indicated, or not, to users of the inventive CVS 10. For example, if a flink entry 54 has one or more resolvable from-locations but no resolvable to-locations, the from-locations (equivalent to departure locations 20) can be emphasized in the pages 14. Similarly, if a flink entry 54 has one or more resolvable to-locations but no resolvable from-locations, the to-locations (equivalent to arrival locations 22) can be emphasized in the pages 14 (say, with a different color). And similarly, a pop-up message can state the number of or details about flink entries 54 that are presently not even partially resolvable.

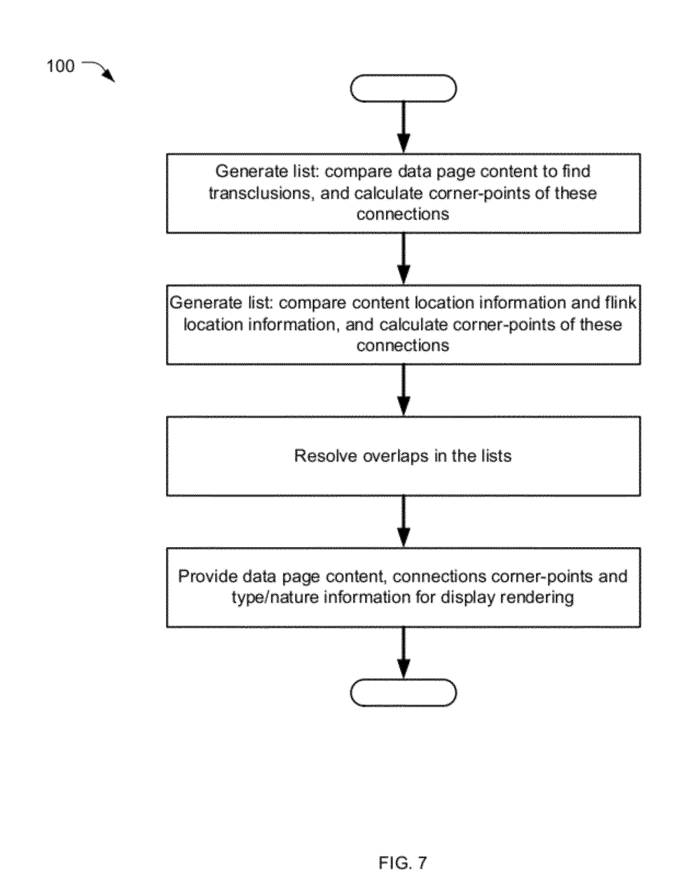

FIG. 7 is a flowchart depicting a routine 100 (termed “xanacrunch” by the inventor) which is usable by the CVS 10 to find the corner-points 26 of the spans 24, and thus to permit the connections 16 (transclusions and flinks) to be properly depicted with their respective pages 14 in the display 12.

In the preferred embodiment of the CVS 10, a software implemented version of this routine 100 is used to perform list comparison on the edit decision list 50 to find the corner-points 26 of the spans 24, and thus to permit the connections 16 (transclusions and flinks) to be properly depicted with their respective pages 14 in the display 12. Since transclusions are not represented in the edit decision list 50, a multi-part comparison is performed. The order of the first two of these parts not important.

One part of this routine 100 is finding the transclusion type connections 16 by comparing the data identified by the respective strand content entries 56, and from this calculating the corner-points 26 of each currently present transclusion type connection 16. In the example in FIGS. 1-5 and 6A-C, the text identified by the respective strand content entries 56 is subjected to a text to text comparison. This can be a literal bit-by-bit comparison, or data “filtering” can be employed. For example text can be converted to a common case (say, to all upper case) or format (e.g., from a mix of ASCII and Unicode to all Unicode), and then bit-by-bit comparison can be employed. Of course, similar types of filtering can be employed with other types of data (e.g., audio, video, etc.).

Another part of the routine 100 is processing the flink type connections 16 that are represented in the edit decision list 50 as the flink entries 54. Pair-wise comparison is performed between the strand entries 52 and the flink entries 54. The strand entries 52 include start and size values from which their respective beginnings and endings can be calculated. The flink entries 54 may include a from (departure) location, with start and size values from which the corner-points 26 for a from/departure span 24 can be calculated. And/or the flink entries 54 may include a to (arrival) location, with start and size values from which the corner-points 26 for a to/arrival span 24 can be calculated. (Note, even if a flink entry 54 lacks explicit from or to information, that flink entry 54 may still be partially processed. Whether a particular embodiment of the CVS 10 does this is a matter of design choice.)

The routine 100 next resolves any overlaps between the two lists created in the earlier parts of the routine 100. Any overlapping spans are calculated (typically there will be many), but this can be simplified by calculating only the corner-points of the spans that are actually needed. (By analogy, this can be similar to how bubble sorts or other “intelligent” data processing techniques improve upon “brute strength” approaches.)

And finally, with the data content of the pages 14, the corner-points 26 of the connections 16, and the nature of those established, rendering what is presented in the display 12 can proceed in typically straightforward and even conventional manner.

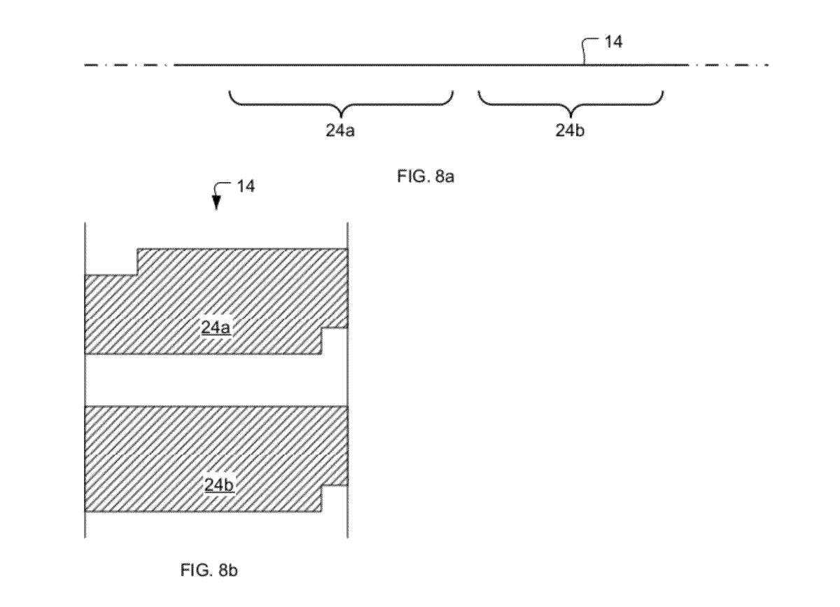

Summarizing, a span 24 is one useful mechanism to define a block of the data in a page 14. A span 24 can be viewed as extending like a long ticker tape, but as a practical matter for many types of data (e.g., text, such as used in the example in FIGS. 1-5 herein), a span 24 can more conveniently be displayed as a block, e.g., blocks that represent sentences, paragraphs, pages (in the way the printed arts use that term), etc. Thus, as shown in FIGS. 8a-b a first span 24a and a second span 24b can be viewed in either of the manners shown.

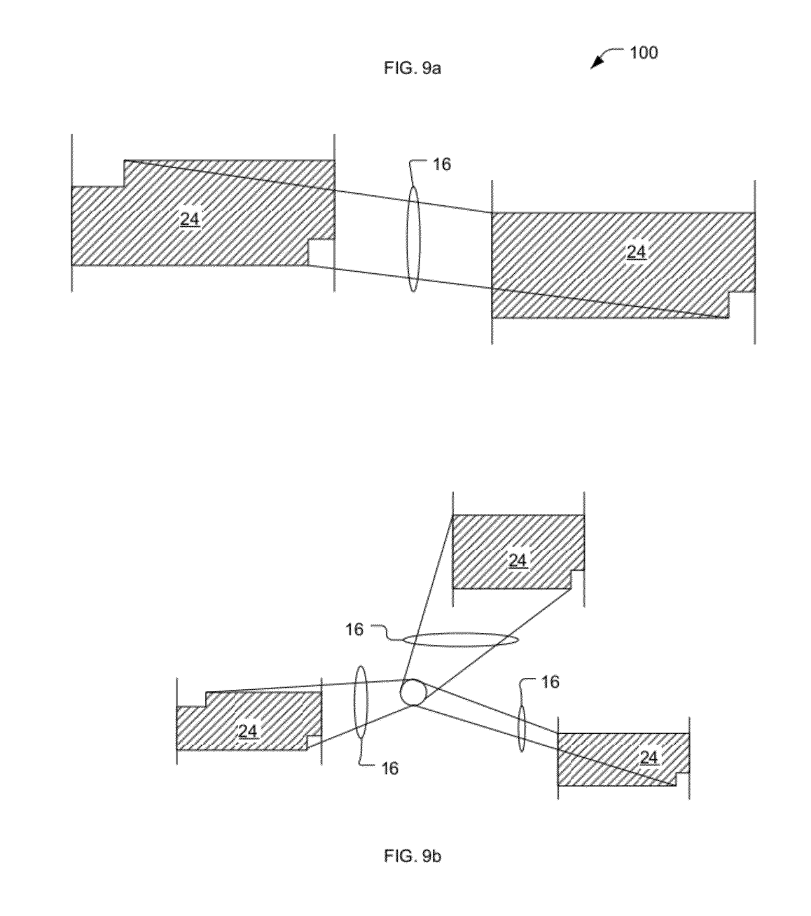

Herein, we are interested in determining and exploring relationships, that is, connections 16 between the data in spans 24, e.g., transclusions, flinks, etc. These relationships are connections 16, and beams are a useful visual mechanism to help display the connections 16. FIG. 9a shows a beam representing a connection 16 in a “simple” context, and FIG. 9b shows beams representing connections 16 in a slightly more complex context. Yet more sophisticated visual mechanisms can help users when exploring data with the inventive CVS 10, such as color (hue, contrast, etc.), shapes, outlining, line emphasis) (e.g., broken, bold, wave-shaped, etc.), but these are straightforward design extensions on the underlying invention as now disclosed.

While various embodiments have been described above, it should be understood that they have been presented by way of example only, and that the breadth and scope of the invention should not be limited by any of the above described exemplary embodiments, but should instead be defined only in accordance with the following claims and their equivalents.

### APPENDIX

This Appendix contains the full content of the Permascroll.txt file used for the examples herein. Due to the inclusion of “non-printable” characters in the original text (e.g., carriage return, line feed, etc.), the values used above for start positions and sizes do not always correlate exactly.

Furthermore, to comply with the U.S. Patent and Trademark Office's rule baring the use of URLs in patent applications, the numerous URLs in the following have been edited by replacing some characters with the character “X.”

Appendix content starts here:

### Origins

How did all this get here? How did we? Where did the earth and the heavens come from? And people?

These must be obvious questions, because they have been answered over and over through the ages, with answers that have been many and varied. Some of the answers are called “religious,” because they involve gods and myths, and some of the answers have been called “scientific,” because they have been advanced by academics. But they have a lot in common.

The number of possible answers continues to grow with scientific progress and with the growth of new religions and their variants. While the number of scientists is greater than ever, the numbers of religions, and of the poor and ignorant, are also greater than ever, so the scientific and religious approaches continue to grow side by side.

The origin of the universe is one thing, the origin of people is another. Somehow there came to be people on the earth; and most agree that the universe came first, before the people. But the Creation stories are very different.

### The Fast Creation of the Universe and People

Western accounts begin with Bibles, the religious books begun by the Hebrews and extended by Christians. All the Bibles have a common account of a busy week when the universe, and the human race, were created by a God who somehow already existed.

The creation of the universe is described in the King James Bible like this:
01:001:001 IN THE BEGINNING GOD CREATED THE HEAVEN AND THE EARTH.
01:001:002 AND THE EARTH WAS WITHOUT FORM, AND VOID; AND DARKNESS WAS UPON THE FACE OF THE DEEP. AND THE SPIRIT OF GOD MOVED UPON THE FACE OF THE WATERS.
01:001:003 AND GOD SAID, LET THERE BE LIGHT: AND THERE WAS LIGHT.

God then goes on to make Eve, she and Adam are expelled from the Garden, they have sons who somehow meet other women and populate the earth.

There are interesting variants. For instance, in one of the Apocrypha (“The Alphabet of Ben Sira”), it is stated that the first woman is Lilith, who refuses to to accept a sex-on-the-bottom position, and to whom Adam grants equality . . .
ADAM AND LILITH IMMEDIATELY BEGAN TO FIGHT. SHE SAID, ‘I WILL NOT LIE BELOW,’ AND HE SAID, ‘I WILL NOT LIE BENEATH YOU, BUT ONLY ON TOP. FOR YOU ARE FIT ONLY TO BE IN THE BOTTOM POSITION, WHILE I AM TO BE THE SUPERIOR ONE.’ LILITH RESPONDED, ‘WE ARE EQUAL TO EACH OTHER INASMUCH AS WE WERE BOTH CREATED FROM THE EARTH.’

But equality is insufficient, and Lilith leaves quickly. The Lilith story is titillating to many with different axes to grind. There is so little authoritative information about Lilith that she can be used to support many different ideas. (She even appears in George Bernard Shaw's play “Back to Methuselah.”)

Of course, Few educated people accept the six-day, Adam-and-Eve account today. It has become literature and myth, and even jokes. Sample joke (from the computer world):
“How was God able to create the universe in only six days.”
Answer: “He didn't have an installed base.”
   (Meaning that there was nothing already there that had to connect to the new universe.)

### The Flood

The different Bibles contain stories that were also kicking around separately in the ancient world, separate from Hebrew culture. For example, we are all familiar with the story of Noah. But there are other accounts of a great and impossible flood that covered the world. The account of the Flood in the book of Genesis has a remarkable parallel to a story of the Flood in a Babylonian stone-tablet document found in Assyria, in the ruined library of Ashurbanipal.

We can consider the story of Noah, and the Assyrian story of the Flood, side by side. (We use floating links to show correspondences between the two accounts.)

In the Hebrew and Christian Bibles, it is the god Jehovah who gives the command to build the ark; in the Babylonian account, it is the god Shamash.

In The Biblical account of the Flood (for instance, the King James version), God tells Noah to build an Ark. In The Babylonian account of the Flood, the instruction is given by a god named Shamash to a “man of Shurippak”, who is told to build a great ship. In both stories the ship is loaded with everything possible, including animals. (See correspondences between the two.)

Then comes the flood; and in both stories the hero releases a bird to see if the land has dried yet. In the Babylonian version, the matter is settled by a raven not coming back; in the King James version, the matter is settled by a dove, who comes back with an olive leaf. (See correspondences between the two.)

Today, few educated people accept the literal account of a Flood which covered the whole earth, with all the land species rescued in a boat; but to the ill-informed people of 3500 years ago, it may have seemed perfectly plausible—particularly since they probably had no idea how many land species existed or how high plateaus and mountains are, or how much water it would take.

### Bibles and Humanoid Gods

The Biblical stories defined western culture, and that of the Mideast as well. But there are many different Bibles—although people who believe strongly in the Bible generally think there is only one. But, as theologian Thomas Long puts it, “BIBLES ARE THE PRODUCTS OF CENTURIES OF THEOLOGICAL AND POLITICAL STRUGGLE.”

Different Bibles include the Hebrew Torah (from which comes the Christian Old Testament), the Coptic Bible, the Catholic Bible in Latin and Greek, the King James Bible (a translation into English for the Anglican denomination), the Catholic translation into English (the Douay Bible), and those of various other denominations, such as the Jehovah's Witnesses and the Mormons.

(To say nothing of the Apocrypha, related books which are halfway out of the Bible. An Apocryphon (singular) is a book originating in Biblical times but not accepted as part of official Bibles. Apocrypha include the books of Ezra, Tobit, Wisdom of Solomon, Epistle of Jeremy, Alphabet of Ben-Sira, and on and on. There is no knowing how many apocrypha there are, or how many more will be discovered.)

But all these different Biblical views assume The notion of a God with particular interest in one species, us, the human race, who supposedly somehow resemble this God, being made in His image. Since we are made in His image, we may assume, for example, that He has a protruding nose and two legs. But if there is such a two-legged God, that implies that the God has physical coordinates somewhere out there, where with good enough telescopes we might see Him kicking around.

In a more serious vein, the Darwinian view is of course that man evolved naturally among the primates, as one particularly versatile variant species of the primate order. Darwin himself states it simply:
THUS WE CAN UNDERSTAND HOW IT HAS COME TO PASS THAT MAN AND ALL OTHER VERTEBRATE ANIMALS HAVE BEEN CONSTRUCTED ON THE SAME GENERAL MODEL, WHY THEY PASS THROUGH THE SAME EARLY STAGES OF DEVELOPMENT, AND WHY THEY RETAIN CERTAIN RUDIMENTS IN COMMON. CONSEQUENTLY WE OUGHT FRANKLY TO ADMIT THEIR COMMUNITY OF DESCENT: TO TAKE ANY OTHER VIEW, IS TO ADMIT THAT OUR OWN STRUCTURE, AND THAT OF ALL THE ANIMALS AROUND US, IS A MERE SNARE LAID TO ENTRAP OUR JUDGMENT.

### What Was The Origin Of The Universe?

Getting back to the universe (as if it were possible to leave it!), our earliest perceptions of it must have been quite simplistic.

If you stand out in the open on a good night, the universe seems to consist of a bowl of sky, across which sun, moon and stars pass at different speeds. This is how it must first have appeared to early human beings. We below seem to stand on an irregular, but relatively flat, earth.

It took us a long time to reach today's understanding of the universe's size and age.

It has taken us a very long time to see that the bowl of the sky only views a portion of a great-three-dimensional space, with millions of stars and galaxies, and ourselves at the lip of Deep Time of billions of years—not the few thousand years of the Bible.

Cosmology is the science of the physics of the universe, including its beginnings. There are many scientific theories of cosmology, but in a way they boil down to only two. Some say the universe has always been here, others say it somehow started. These are the two basic views: the steady-state view and the Big Bang view.

### Steady State

The steady-state theory of Fred Hoyle (also Bondi and Gold) says that the universe has always been pretty much the way it is, except that it continues to expand and matter flies away. To keep things steady, the steady-state theory proposed a process of continuous uniform creation—where new matter is continuously created to make up for the matter that flies away.

According to this view, the universe had no beginning and will have no end.

HOYLE APPROACHED THE PROBLEM MATHEMATICALLY AND TRIED TO SOLVE THE PROBLEM OF THE CREATION OF THE MATTER SEEN ALL AROUND US, WHICH IN THE BIG BANG THEORY IS ALL CREATED AT THE START. HE PROPOSED THAT THE DECREASE IN THE DENSITY OF THE UNIVERSE CAUSED BY ITS EXPANSION IS EXACTLY BALANCED BY THE CONTINUOUS CREATION OF MATTER CONDENSING INTO GALAXIES THAT TAKE THE PLACE OF THE GALAXIES THAT HAVE RECEDED FROM THE MILKY WAY, THEREBY MAINTAINING FOREVER THE PRESENT APPEARANCE OF THE UNIVERSE.

### The Big Bang Theory

The Big Bang theory (a term coined by Fred Hoyle, who did not like the theory) takes the position that all matter and energy was created at one instant, and the universe has flown apart ever since. (Hawking has publicized this view considerably.)

At the instant of Beginning, all matter and potential energy were infinitely compressed to a single point. Then time began and in the first fraction of a second this compressed conglomerate exploded, flying apart into a mutual web of co-created space and matter and energy.

After the first couple of hours, things became relatively eventful and familiar, and soon stars emerged, and the rest is history.

Today this theory is much more popular than Steady State, which indeed many cosmologists regard as disproven. It is said that ALONE AMONG ALL COSMOLOGIES, THE STEADY STATE MODEL MAKES SUCH DEFINITE PREDICTIONS THAT IT CAN BE DISPROVED EVEN WITH THE LIMITED OBSERVATIONAL EVIDENCE AT OUR DISPOSAL.

However, science is always twisting and turning, with new possibilities opening at every turn. For instance, a new theory called “chaotic inflation theory” has recently appeared—“CHAOTIC INFLATION THEORY OR ETERNAL INFLATION WHICH SOMETIMES POSITS AN INFINITE UNIVERSE WITH NEITHER BEGINNING NOR END IN WHICH INFLATION OPERATES CONTINUOUSLY, ON A SCALE BEYOND THE OBSERVABLE UNIVERSE, TO CREATE THE MATTER OF THE COSMOS.”

It seems this is reviving the steady-state view, with new twists. CHAOTIC INFLATION THEORY HAS MANY SIMILARITIES WITH STEADY STATE THEORY, ALTHOUGH ON A MUCH LARGER SCALE THAN ORIGINALLY ENVISAGED. Hoyle, who is now in a permanent steady state (he died in 2001), would be pleased.

### Objectivity

Scientific “objectivity” is not what most people think. There are always biases.

It is interesting to see the motivations and attitudes behind the theories. For instance, religion (pro and con) continues to be a motivating force behind scientific theory.

An example: physicist Georges Lemaitre, one of the originators of the “Big Bang” theory, had an implicit religious position. Lemaitre, AS HE WAS ALSO AN ABBOT OF THE ROMAN CATHOLIC CHURCH ARGUED THAT GOD HAD CREATED ‘A PRIMEVAL ATOM’WHICH HAD GROWN TO BECOME THE UNIVERSE.”

Whereas Fred Hoyle, the best-known exponent of the Steady-State theory, was protecting an atheistic position: “FRED HOYLE WAS UNHAPPY ABOUT ACCEPTING A GOD GIVEN CREATION, AND AS AN ATHEIST ATTEMPTED TO DEVELOP A THEORY WITHOUT SUCH AN INTERVENTION. THIS WAS TO BECOME THE STEADY STATE THEORY.”

Aesthetics, too, plays a part. Theories are supposed to make sense and hold together; aspects which break the unity are an affront, as when scientists refer to “AN AESTHETICALLY UNATTRACTIVE FEATURE OF THE THEORY”.

Art, too, can inspire science. Another non-scientific inspiration for the Steady-State theory came from a popular horror movie: THE STEADY STATE THEORY OF BONDI, GOLD AND HOYLE WAS INSPIRED BY THE CIRCULAR PLOT OF THE FILM DEAD OF NIGHT THEY WATCHED TOGETHER.

This is interesting, because The film “Dead of Night” was an extremely good, clever and scary postwar horror movie. Its final plot twist: its end is also its beginning, starting the story all over again. So the viewer, about to be relieved that the film is over, suddenly understands that it will never be over—thus perpetuating, in principle, the scariness.

So much repeats, so much goes on. The universe is here, and so are people. What to think about it all can be daunting. What to do about it is another question. [Title: Excerpt from apocryphon, The Alphabet of Ben Sira]

After God created Adam, who was alone, He said, ‘It is not good for man to be alone’. He then created a woman for Adam, from the earth, as He had created Adam himself, and called her Lilith. Adam and Lilith immediately began to fight. She said, ‘I will not lie below,’ and he said, ‘I will not lie beneath you, but only on top. For you are fit only to be in the bottom position, while I am to be the superior one.’ Lilith responded, ‘We are equal to each other inasmuch as we were both created from the earth.’ But they would not listen to one another. When Lilith saw this, she pronounced the Ineffable Name and flew away into the air. Adam stood in prayer before his Creator: ‘Sovereign of the universe!’ he said, ‘the woman you gave me has run away.’ At once, the Holy One, blessed be He, sent these three angels to bring her back.

Said the Holy One to Adam, ‘If she agrees to come back, fine. If not, she must permit one hundred of her children to die every day.’ The angels left God and pursued Lilith, whom they overtook in the midst of the sea, in the mighty waters wherein the Egyptians were destined to drown. They told her God's word, but she did not wish to return. The angels said, ‘We shall drown you in the sea.’

‘Leave me!’ she said. ‘I was created only to cause sickness to infants. If the infant is male, I have dominion over him for eight days after his birth, and if female, for twenty days.’

When the angels heard Lilith's words, they insisted she go back. But she swore to them by the name of the living and eternal God: ‘Whenever I see you or your names or your forms in an amulet, I will have no power over that infant.’ She also agreed to have one hundred of her children die every day. Accordingly, every day one hundred demons perish, and for the same reason, we write the angels names on the amulets of young children. When Lilith sees their names, she remembers her oath, and the child recovers.

[from Wikipedia, January 2007]

[title: From THE DESCENT OF MAN, Chapter 1, by Charles Darwin]

Thus we can understand how it has come to pass that man and all other vertebrate animals have been constructed on the same general model, why they pass through the same early stages of development, and why they retain certain rudiments in common. Consequently we ought frankly to admit their community of descent: to take any other view, is to admit that our own structure, and that of all the animals around us, is a mere snare laid to entrap our judgment. This conclusion is greatly strengthened, if we look to the members of the whole animal series, and consider the evidence derived from their affinities or classification, their geographical distribution and geological succession. It is only our natural prejudice, and that arrogance which made our forefathers declare that they were descended from demi-gods, which leads us to demur to this conclusion. But the time will before long come, when it will be thought wonderful that naturalists, who were well acquainted with the comparative structure and development of man, and other mammals, should have believed that each was the work of a separate act of creation.

[from Project Gutenberg] [Excerpt: “Dead of Night” review from britishhorrorfilms.co.uk]

### Dead of Night

1945

It would be safe to say that most of the films on this site aren't particularly frightening. . . .

[The content of the original of this excellent review is redacted here to respect the owner's copyrights.]
If you haven't seen the film, why not? And if you don't agree, fair enough. I am a bit of a nancy boy.
from hXXp://wXw.britishhorrorfilms.co.uk/deadofnight.shtml

[Title: Gilgamish Epic, The Flood]

The Eleventh Tablet of the Gilgamish Series containing the Story of the Deluge as told to Gilgamish by his deified ancestor Uta-Napishtim, an antediluvian king of Erech.
1. Gilgamish said unto Uta-Napishtim, to Uta-Napishtim the remote:
2. “I am looking at thee, Uta-Napishtim.
3. Thy person is not altered; even as am I so art thou.
4. Verily, nothing about thee is changed; even as am I so art thou.
5. [Moved is my] heart to do battle,
6. But thou art at leisure and dost lie upon thy back.

7. How then wast thou able to enter the company of the gods and see life?”

Thereupon Uta-Napishtim related to Gilgamish the Story of the Deluge, and the Eleventh Tablet continues thus:—
8. Uta-Napishtim said unto him, to Gilgamish:
9. “I will reveal unto thee, 0 Gilgamish, a hidden mystery,
10. And a secret matter of the gods I will declare unto thee.
11. Shurippak, 2 a city which thou thyself knowest,
12. On [the bank] of the river Puratti (Euphrates) is situated,
13. That city was old and the gods [dwelling] within it
14. Their hearts induced the great gods to make a wind-storm (, a-bu-bi), 3
15. Their father Anu ( ),
16. Their counsellor, the warrior Enlil ( ),
17. Their messenger En-urta ( )[and]
18. Their prince Ennugi ( ).
19. Nin-igi-azag, Ea, was with them [in council] and
20. reported their word to the house of reeds.

[First Speech of Ea to Uta-Napishtim who is sleeping in a reed hut.]
21. O House of reeds, O House of reeds! O Wall, O Wall! page 33
22. 0 House of reeds, hear! O Wall, understand!
23. O man of Shurippak, son of Ubara-Tutu ( ).
24. Throw down the house, build a ship,
25. Forsake wealth, seek after life,
26. Abandon possessions, save thy life,
27. Carry grain of every kind into the ship.
28. The ship which thou shalt build,
29. The dimensions thereof shall be measured,
30. The breadth and the length thereof shall be the same.
31. . . . the ocean, provide it with a roof.”

[Uta-Napishtim's answer to Ea.]
32. “I understood and I said unto Ea, my lord:
33. [I comprehend] my lord, that which thou hast ordered,
34. I will regard it with great reverence, and will perform it.

35. But what shall I say to the town, to the multitude, and to the elders?”

[Second Speech of Ea.]
36. “Ea opened his mouth and spake
37. And said unto his servant, myself,
38. . . . Thus shalt thou say unto them:
39. Ill-will hath the god Enlil formed against me,
40. Therefore I can no longer dwell in your city,
41. And never more will I turn my countenance upon the soil of Enlil.
42. I will descend into the ocean to dwell with my lord Ea.
43. But upon you he will rain riches:
44. A catch of birds, a catch of fish
45. . . . an [abundant] harvest,
46. . . . the prince (?) of the darkness
47. . . . shall make a violent cyclone [to fall upon you].”

[The Building of the Ship.]
48. As soon as [the dawn] broke . . .

[Lines 49-54 broken away.]
55. The weak [man] . . . brought bitumen,
56. The strong [man] . . . brought what was needed. page 34
57. On the fifth day I decided upon its plan.
58. According to the plan its walls were 10 Gar (i.e. 120 cubits) high,
59. And the circuit of the roof thereof was equally 10 Gar.
60. I measured out the hull thereof and marked it out (?)
61. I covered (?) it six times.
62. Its exterior I divided into seven,
63. Its interior I divided into nine,
64. Water bolts I drove into the middle of it.
65. I provided a steering pole, and fixed what was needful for it,
66. Six sar of bitumen I poured over the inside wall,
67. Three sar of pitch I poured into the inside.
68. The men who bear loads brought three sar of oil,
69. Besides a sar of oil which the offering consumed,
70. And two sar of oil which the boatman hid.
71. I slaughtered oxen for the [work] people,
72. I slew sheep every day.
73. Beer, sesame wine, oil and wine
74. I made the people drink as if they were water from the river.
75. I celebrated a feast-day as if it had been New Year's Day.
76. I opened [a box of ointment], I laid my hands in unguent.
77. Before the sunset the ship was finished.
78. [Since] . . . was difficult.
79. The shipbuilders brought the . . . of the ship, above and below,
80. . . . two-thirds of it.

[The Loading of the Ship.]
81. With everything that I possessed I loaded it (i.e. the ship).
82. With everything that I possessed of silver I loaded it.
83. With everything that I possessed of gold I loaded it.
84. With all that I possessed of living grain I loaded it.
85. I made to go up into the ship all my family and kinsfolk, page 35
86. The cattle of the field, the beasts of the field, all handicraftsmen I made them go up into it.
87. The god Shamash had appointed me a time (saying)
88. The Power of Darkness will at eventide make a rain-flood to fall;
89. Then enter into the ship and shut thy door.
90. The appointed time drew nigh;
91. The Power of Darkness made a rain-flood to fall at eventide.
92. I watched the coming of the [approaching] storm,
93. “When I saw it tenor possessed me,
94. I went into the ship and shut my door.
95. To the pilot of the ship, Puzur-Bêl (or Puzur-Amurri) the sailor
96. I committed the great house (i.e. ship), together with the contents thereof.

[The Abubu (Cyclone) and its effects Described.]
97. As soon as the gleam of dawn shone in the sky
98. A black cloud from the foundation of heaven came up.
99. Inside it the god Adad (Rammânu) thundered,
100. The gods Nabû and Sharru (i.e. Marduk) went before,
101. Marching as messengers over high land and plain,
102. Irragal (Nergal) tore out the post of the ship,
103. En-urta (Ninib) went on, he made the storm to descend.
104. The Anunnaki4 brandished their torches,
105. With their glare they lighted up the land.
106. The whirlwind (or, cyclone) of Adad swept up to heaven.
107. Every gleam of light was turned into darkness.
108. . . . the land as if had laid it waste.
109. A whole day long [the flood descended] . . .
110. Swiftly it mounted up . . . [the water] reached to the mountains
111. [The water] attacked the people like a battle.
112. Brother saw not brother. page 36
113. Men could not be known (or, recognized) in heaven.
114. The gods were terrified at the cyclone.
115. They betook themselves to flight and went up into the heaven of Anu.
116. The gods crouched like a dog and cowered by the wall.
117. The goddess Ishtar cried out like a woman in travail.
118. The Lady of the Gods lamented with a loud voice [saying]:

[Ishtar's Lament.]
119. “Verily the former dispensation is turned into mud,
120. Because I commanded evil among the company of the gods.
121. When I commanded evil among the company of the gods,
122. I commanded battle for the destruction of my people.
123. Did I of myself bring forth my people
124. That they might fill the sea like little fishes?”

[Uta-Napishtim's Story continued.]
125. The gods of the Anunnaki wailed with her.
126. The gods bowed themselves, and sat down, and wept.
127. Their lips were shut tight (in distress) . . .
128. For six days and nights
129. The storm raged, and the cyclone overwhelmed the land. [The Abating of the Storm.]
130. When the seventh day approached the cyclone and the raging flood ceased:
131.—now it had fought like an army.
132. The sea became quiet and went down, and the cyclone and the rain-storm ceased.
133. I looked over the sea and a calm had come,
134. And all mankind were turned into mud,
135. The land had been laid flat like a terrace.
136. I opened the air-hole and the light fell upon my face,
137. I bowed myself, I sat down, I cried,
138. My tears poured down over my cheeks. page 37
139. I looked over the quarters of the world—open sea!
140. After twelve days an island appeared.
141. The ship took its course to the land of Nisir ( ).
142. The mountain of Nisir held the ship, it let it not move.
143. The first day, the second day, the mountain of Nisir held the ship and let it not move.
144. The third day, the fourth day, the mountain of Nisir held the ship and let it not move.
145. The fifth day, the sixth day, the mountain of Nisir held the ship and let it not move.
146. When the seventh day had come
147. I brought out a dove and let her go free.
148. The dove flew away and [then] came back;
149. Because she had no place to alight on she came back.
150. I brought out a swallow and let her go free.
151. The swallow flew away and [then] came back;
152. Because she had no place to alight on she came back.
153. I brought out a raven and let her go free.
154. The raven flew away, she saw the sinking waters.
155. She ate, she pecked in the ground, she croaked, she came not back.

[Uta-Napishtim Leaves the Ship.]
156. Then I brought out everything to the four winds and offered up a sacrifice;
157. I poured out a libation on the peak of the mountain.
158. Seven by seven I set out the vessels,
159. Under them I piled reeds, cedarwood and myrtle (?).
160. The gods smelt the savour,
161. The gods smelt the sweet savour.
162. The gods gathered together like flies over him that sacrificed.

[Speech of Ishtar, Lady of the Gods.]
163. Now when the Lady of the Gods came nigh,
164. She lifted up the priceless jewels which Anu had made according to her desire, [saying]
165. “O ye gods here present, as I shall never forget the lapis-lazuli jewels of my neck page 39
166. So shall I ever think about these days, and shall forget them nevermore!
167. Let the gods come to the offering,
168. But let not Enlil come to the offering,
169. Because he would not accept counsel and made the cyclone,
170. And delivered my people over to destruction.”

[The Anger of Enlil (Bêl).]
171. Now when Enlil came nigh
172. He saw the ship; then was Enlil wroth
173. And he was filled with anger against the gods, the Igigi [saying]: 5
174. “What kind of a being hath escaped with his life?
175. He shall not remain alive, a man among the destruction!”

[Speech of En-Urta.]
176. Then En-Urta opened his mouth and spake
177. And said unto the warrior Enlil (Bêl):
178. Who besides the god Ea can make a plan?
179. The god Ea knoweth everything.
180. He opened his mouth and spake
181. And said unto the warrior Enlil (Bêl),
182. O Prince among the gods, thou warrior,
183. How couldst thou, not accepting counsel, make a cyclone?
184. He who is sinful, on him lay his sin,
185. He who transgresseth, on him lay his transgression.
186. But be merciful that [everything] be not destroyed; be long-suffering that [man be not blotted out].
187. Instead of thy making a cyclone,
188. Would that a lion had come and diminished mankind.
189. Instead of thy making a cyclone
190. Would that a wolf had come and diminished mankind.
191. Instead of thy making a cyclone page 40
192. Would that a famine had arisen and [laid waste] the land.
193. Instead of thy making a cyclone
194. Would that Urra (, the Plague god) had risen up and [laid waste] the land.
195. As for me I have not revealed the secret of the great gods.
196. I made Atra-hasis ( )to see a vision, and thus he heard the secret of the gods.
197. Now therefore counsel him with counsel.”

[Ea deifies Uta-Napishtim and his Wife.]
198. “Then the god Ea went up into the ship,
199. He seized me by the hand and brought me forth.
200. He brought forth my wife and made her to kneel by my side.
201. He turned our faces towards each other, he stood between us, he blessed us [saying],
202. Formerly Uta-Napishtim was a man merely,
203. But now let Uta-Napishtim and his wife be like unto the gods, ourselves.
204. Uta-Napishtim shall dwell afar off, at the mouth of the rivers.”

[Uta-Napishtim Ends his Story of the Deluge.]

205. “And they took me away to a place afar off, and made me to dwell at the mouth of the rivers.”
from Project Gutenberg [Title: King James Bible, The Creation]

### Book 01 Genesis

01:001:001 In the beginning God created the heaven and the earth.
01:001:002 And the earth was without form, and void; and darkness was upon the face of the deep. And the Spirit of God moved upon the face of the waters.
01:001:003 And God said, Let there be light: and there was light.
01:001:004 And God saw the light, that it was good: and God divided the light from the darkness.
01:001:005 And God called the light Day, and the darkness he called Night. And the evening and the morning were the first day.
01:001:006 And God said, Let there be a firmament in the midst of the waters, and let it divide the waters from the waters.
01:001:007 And God made the firmament, and divided the waters which were under the firmament from the waters which were above the firmament: and it was so.
01:001:008 And God called the firmament Heaven. And the evening and the morning were the second day.
01:001:009 And God said, Let the waters under the heaven be gathered together unto one place, and let the dry land appear: and it was so.
01:001:010 And God called the dry land Earth; and the gathering together of the waters called he Seas: and God saw that it was good.
01:001:011 And God said, Let the earth bring forth grass, the herb yielding seed, and the fruit tree yielding fruit after his kind, whose seed is in itself, upon the earth: and it was so.
01:001:012 And the earth brought forth grass, and herb yielding seed after his kind, and the tree yielding fruit, whose seed was in itself, after his kind: and God saw that it was good.
01:001:013 And the evening and the morning were the third day.
01:001:014 And God said, Let there be lights in the firmament of the heaven to divide the day from the night; and let them be for signs, and for seasons, and for days, and years:
01:001:015 And let them be for lights in the firmament of the heaven to give light upon the earth: and it was so.
01:001:016 And God made two great lights; the greater light to rule the day, and the lesser light to rule the night: he made the stars also.
01:001:017 And God set them in the firmament of the heaven to give light upon the earth,
01:001:018 And to rule over the day and over the night, and to divide the light from the darkness: and God saw that it was good.
01:001:019 And the evening and the morning were the fourth day.
01:001:020 And God said, Let the waters bring forth abundantly the moving creature that hath life, and fowl that may fly above the earth in the open firmament of heaven.
01:001:021 And God created great whales, and every living creature that moveth, which the waters brought forth abundantly, after their kind, and every winged fowl after his kind: and God saw that it was good.
01:001:022 And God blessed them, saying, Be fruitful, and multiply, and fill the waters in the seas, and let fowl multiply in the earth.
01:001:023 And the evening and the morning were the fifth day.
01:001:024 And God said, Let the earth bring forth the living creature after his kind, cattle, and creeping thing, and beast of the earth after his kind: and it was so.
01:001:025 And God made the beast of the earth after his kind, and cattle after their kind, and every thing that creepeth upon the earth after his kind: and God saw that it was good.
01:001:026 And God said, Let us make man in our image, after our likeness: and let them have dominion over the fish of the sea, and over the fowl of the air, and over the cattle, and over all the earth, and over every creeping thing that creepeth upon the earth.
01:001:027 So God created man in his own image, in the image of God created he him; male and female created he them.
01:001:028 And God blessed them, and God said unto them, Be fruitful, and multiply, and replenish the earth, and subdue it: and have dominion over the fish of the sea, and over the fowl of the air, and over every living thing that moveth upon the earth.
01:001:029 And God said, Behold, I have given you every herb bearing seed, which is upon the face of all the earth, and every tree, in the which is the fruit of a tree yielding seed; to you it shall be for meat.
01:001:030 And to every beast of the earth, and to every fowl of the air, and to every thing that creepeth upon the earth, wherein there is life, I have given every green herb for meat: and it was so.
01:001:031 And God saw every thing that he had made, and, behold, it was very good. And the evening and the morning were the sixth day.
01:002:001 Thus the heavens and the earth were finished, and all the host of them.
01:002:002 And on the seventh day God ended his work which he had made; and he rested on the seventh day from all his work which he had made.
01:002:003 And God blessed the seventh day, and sanctified it: because that in it he had rested from all his work which God created and made.
01:002:004 These are the generations of the heavens and of the earth when they were created, in the day that the LORD God made the earth and the heavens,
01:002:005 And every plant of the field before it was in the earth, and every herb of the field before it grew: for the LORD God had not caused it to rain upon the earth, and there was not a man to till the ground.
01:002:006 But there went up a mist from the earth, and watered the whole face of the ground.
01:002:007 And the LORD God formed man of the dust of the ground, and breathed into his nostrils the breath of life; and man became a living soul.
01:002:008 And the LORD God planted a garden eastward in Eden; and there he put the man whom he had formed.
01:002:009 And out of the ground made the LORD God to grow every tree that is pleasant to the sight, and good for food; the tree of life also in the midst of the garden, and the tree of knowledge of good and evil.
01:002:010 And a river went out of Eden to water the garden; and from thence it was parted, and became into four heads.
01:002:011 The name of the first is Pison: that is it which compasseth the whole land of Havilah, where there is gold;
01:002:012 And the gold of that land is good: there is bdellium and the onyx stone.
01:002:013 And the name of the second river is Gihon: the same is it that compasseth the whole land of Ethiopia.
01:002:014 And the name of the third river is Hiddekel: that is it which goeth toward the east of Assyria. And the fourth river is Euphrates.
01:002:015 And the LORD God took the man, and put him into the garden of Eden to dress it and to keep it.
01:002:016 And the LORD God commanded the man, saying, Of every tree of the garden thou mayest freely eat:
01:002:017 But of the tree of the knowledge of good and evil, thou shalt not eat of it: for in the day that thou eatest thereof thou shalt surely die.
01:002:018 And the LORD God said, It is not good that the man should be alone; I will make him an help meet for him.
01:002:019 And out of the ground the LORD God formed every beast of the field, and every fowl of the air; and brought them unto Adam to see what he would call them: and whatsoever Adam called every living creature, that was the name thereof.
01:002:020 And Adam gave names to all cattle, and to the fowl of the air, and to every beast of the field; but for Adam there was not found an help meet for him.
01:002:021 And the LORD God caused a deep sleep to fall upon Adam, and he slept: and he took one of his ribs, and closed up the flesh instead thereof;
01:002:022 And the rib, which the LORD God had taken from man, made he a woman, and brought her unto the man.
01:002:023 And Adam said, This is now bone of my bones, and flesh of my flesh: she shall be called Woman, because she was taken out of Man.
01:002:024 Therefore shall a man leave his father and his mother, and shall cleave unto his wife: and they shall be one flesh.
01:002:025 And they were both naked, the man and his wife, and were not ashamed.
01:003:001 Now the serpent was more subtil than any beast of the field which the LORD God had made. And he said unto the woman, Yea, hath God said, Ye shall not eat of every tree of the garden?
01:003:002 And the woman said unto the serpent, We may eat of the fruit of the trees of the garden:
01:003:003 But of the fruit of the tree which is in the midst of the garden, God hath said, Ye shall not eat of it, neither shall ye touch it, lest ye die.
01:003:004 And the serpent said unto the woman, Ye shall not surely die:
01:003:005 For God doth know that in the day ye eat thereof, then your eyes shall be opened, and ye shall be as gods, knowing good and evil.
01:003:006 And when the woman saw that the tree was good for food, and that it was pleasant to the eyes, and a tree to be desired to make one wise, she took of the fruit thereof, and did eat, and gave also unto her husband with her; and he did eat.
01:003:007 And the eyes of them both were opened, and they knew that they were naked; and they sewed fig leaves together, and made themselves aprons.
   from Project Gutenberg [Title: King James Bible, The Flood]
01:006:012 And God looked upon the earth, and, behold, it was corrupt; for all flesh had corrupted his way upon the earth.
01:006:013 And God said unto Noah, The end of all flesh is come before me; for the earth is filled with violence through them; and, behold, I will destroy them with the earth.
01:006:014 Make thee an ark of gopher wood; rooms shalt thou make in the ark, and shalt pitch it within and without with pitch.
01:006:015 And this is the fashion which thou shalt make it of: The length of the ark shall be three hundred cubits, the breadth of it fifty cubits, and the height of it thirty cubits.
01:006:016 A window shalt thou make to the ark, and in a cubit shalt thou finish it above; and the door of the ark shalt thou set in the side thereof; with lower, second, and third stories shalt thou make it.
01:006:017 And, behold, I, even I, do bring a flood of waters upon the earth, to destroy all flesh, wherein is the breath of life, from under heaven; and every thing that is in the earth shall die.
01:006:018 But with thee will I establish my covenant; and thou shalt come into the ark, thou, and thy sons, and thy wife, and thy sons' wives with thee.
01:006:019 And of every living thing of all flesh, two of every sort shalt thou bring into the ark, to keep them alive with thee; they shall be male and female.
01:006:020 Of fowls after their kind, and of cattle after their kind, of every creeping thing of the earth after his kind, two of every sort shall come unto thee, to keep them alive.
01:006:021 And take thou unto thee of all food that is eaten, and thou shalt gather it to thee; and it shall be for food for thee, and for them.
01:006:022 Thus did Noah; according to all that God commanded him, so did he.
01:007:001 And the LORD said unto Noah, Come thou and all thy house into the ark; for thee have I seen righteous before me in this generation.
01:007:002 Of every clean beast thou shalt take to thee by sevens, the male and his female: and of beasts that are not clean by two, the male and his female.
01:007:003 Of fowls also of the air by sevens, the male and the female; to keep seed alive upon the face of all the earth.
01:007:004 For yet seven days, and I will cause it to rain upon the earth forty days and forty nights; and every living substance that I have made will I destroy from off the face of the earth.
01:007:005 And Noah did according unto all that the LORD commanded him.
01:007:006 And Noah was six hundred years old when the flood of waters was upon the earth.
01:007:007 And Noah went in, and his sons, and his wife, and his sons' wives with him, into the ark, because of the waters of the flood.
01:007:008 Of clean beasts, and of beasts that are not clean, and of fowls, and of every thing that creepeth upon the earth,
01:007:009 There went in two and two unto Noah into the ark, the male and the female, as God had commanded Noah.
01:007:010 And it came to pass after seven days, that the waters of the flood were upon the earth.
01:007:011 In the six hundredth year of Noah's life, in the second month, the seventeenth day of the month, the same day were all the fountains of the great deep broken up, and the windows of heaven were opened.
01:007:012 And the rain was upon the earth forty days and forty nights.
01:007:013 In the selfsame day entered Noah, and Shem, and Ham, and Japheth, the sons of Noah, and Noah's wife, and the three wives of his sons with them, into the ark;
01:007:014 They, and every beast after his kind, and all the cattle after their kind, and every creeping thing that creepeth upon the earth after his kind, and every fowl after his kind, every bird of every sort.
01:007:015 And they went in unto Noah into the ark, two and two of all flesh, wherein is the breath of life.
01:007:016 And they that went in, went in male and female of all flesh, as God had commanded him: and the LORD shut him in.
01:007:017 And the flood was forty days upon the earth; and the waters increased, and bare up the ark, and it was lift up above the earth.
01:007:018 And the waters prevailed, and were increased greatly upon the earth; and the ark went upon the face of the waters.
01:007:019 And the waters prevailed exceedingly upon the earth; and all the high hills, that were under the whole heaven, were covered.
01:007:020 Fifteen cubits upward did the waters prevail; and the mountains were covered.
01:007:021 And all flesh died that moved upon the earth, both of fowl, and of cattle, and of beast, and of every creeping thing that creepeth upon the earth, and every man:
01:007:022 All in whose nostrils was the breath of life, of all that was in the dry land, died.
01:007:023 And every living substance was destroyed which was upon the face of the ground, both man, and cattle, and the creeping things, and the fowl of the heaven; and they were destroyed from the earth: and Noah only remained alive, and they that were with him in the ark.
01:007:024 And the waters prevailed upon the earth an hundred and fifty days.
01:008:001 And God remembered Noah, and every living thing, and all the cattle that was with him in the ark: and God made a wind to pass over the earth, and the waters asswaged;
01:008:002 The fountains also of the deep and the windows of heaven were stopped, and the rain from heaven was restrained;
01:008:003 And the waters returned from off the earth continually: and after the end of the hundred and fifty days the waters were abated.
01:008:004 And the ark rested in the seventh month, on the seventeenth day of the month, upon the mountains of Ararat.
01:008:005 And the waters decreased continually until the tenth month: in the tenth month, on the first day of the month, were the tops of the mountains seen.
01:008:006 And it came to pass at the end of forty days, that Noah opened the window of the ark which he had made:
01:008:007 And he sent forth a raven, which went forth to and fro, until the waters were dried up from off the earth.
01:008:008 Also he sent forth a dove from him, to see if the waters were abated from off the face of the ground;
01:008:009 But the dove found no rest for the sole of her foot, and she returned unto him into the ark, for the waters were on the face of the whole earth: then he put forth his hand, and took her, and pulled her in unto him into the ark.
01:008:010 And he stayed yet other seven days; and again he sent forth the dove out of the ark;
01:008:011 And the dove came in to him in the evening; and, lo, in her mouth was an olive leaf pluckt off: so Noah knew that the waters were abated from off the earth.
01:008:012 And he stayed yet other seven days; and sent forth the dove; which returned not again unto him any more.
01:008:013 And it came to pass in the six hundredth and first year, in the first month, the first day of the month, the waters were dried up from off the earth: and Noah removed the covering of the ark, and looked, and, behold, the face of the ground was dry.
   from Project Gutenberg [title: Excerpt from “A History of Composition and Interpretation”, by Dr. Thomas L. Long”

Bibles are the products of centuries of theological and political struggle. In the most obvious sense,
what Jews consider to be “the Bible” and what Christians consider to be “the Bible” are based on agreements about the role of Judaism in salvation history but disagreements about the significance of
Jesus of Nazareth. Which texts are considered authoritative and divinely inspired (and therefore included in the Bible) is the question of the canon. Obviously, the Jewish canon differs from the Christian canon. However, it is also important to note that even among Jews and among Christians
there was not complete agreement upon the canon, particularly that of the Jewish scriptures, what Christians call the Old Testament.
from
hXXp://community.tncc.edu/faculty/longt/REL210/history_of_composition_and_interpretation.htm[title: Excerpt from “The Big Bang Theory,” from SchoolsObservatory.org.uk]

Willem de Sitter was the first to show that the universe must expand. His prediction was improved by Alexander Alexandrovich Friedmann in 1922, and further refined by Arthur Stanley Eddington in 1930. Georges Lemaitre, in 1927, thought about the consequences in a slightly different way. If the universe was ahead expanding gravity could slow the expansion, but not necessarily stop it and cause collapse. He realised that an expanding universe would have been smaller yesterday than today and so on, all the way back to a ‘day that would not have had a yesterday’. He argued that that instant would have been the moment of creation, and as he was also an abbot of the Roman Catholic church argued that God had created ‘a primeval atom’ which had grown to become the Universe. Lemaitre's main interest in the primeval atom was as a source of all other atoms, which he imagined taking place by a process of continual fission. Initially Einstein thought that Lemaitre did not understand the physics properly and dismissed the idea, but later after Hubble's discovery of the expansion, Lemaitre gave a lecture at which both Hubble and Einstein were present in which Einstein proclaimed, “[what he had just heard] was the most beautiful and satisfying interpretation I have ever listened to” and admitted that the cosmological constant had been an error.

Not everyone accepted the idea of a moment of creation. Fred Hoyle was unhappy about accepting a God given creation, and as an atheist attempted to develop a theory without such an intervention. This was to become the steady state theory. His principal challenge to Lemaitre's theory was that there was no ‘fossil’ record. In an attack on the theory he had dismissively referred to “this hot Big Bang” and the name stuck. In the same year as steady state was published, 1948, George Gamow and his student Ralph Alpher, proposed that if the universe was created in a gigantic explosion that the various elements observed today would be produced within the first few minutes after the big bang, when the extremely high temperature and density of the universe would fuse subatomic particles into the chemical elements.
from hXXp://wXw.schoolsobservatory.org.uk/study/sci/cosmo/internal/bigbang.htm[title: Excerpt from “The Steady-State Theory,” from SchoolsObservatory.org.uk]

### The Steady-State Theory

An alternative theory to the Big Bang was proposed in 1948 by Hermann Bondi, Thomas Gold, and Sir Fred Hoyle It was called the steady-state theory. They found the idea of a sudden beginning to the universe philosophically unsatisfactory. Bondi and Gold suggested that in order to understand the universe we needed to make observations of its distant parts, which would of necessity be observations from the past. In order to interpret those observations we must use the laws of physics, and those have been formulated at the present time. If the state of the universe was different in the past how could we be sure that the laws of physics were not different in the past as well? If they were different no valid conclusions could be drawn. For Bondi and Gold not only would the laws of physics have to be the same in all parts of the universe, but at all times as well. The Universe would also be the same, always static, always contracting or always expanding. The first two could be ruled ut by the simple observation that the sky is dark at night. (see Olber's Paradox)

Hoyle approached the problem mathematically and tried to solve the problem of the creation of the matter seen all around us, which in the Big Bang theory is all created at the start. He proposed that the decrease in the density of the universe caused by its expansion is exactly balanced by the continuous creation of matter condensing into galaxies that take the place of the galaxies that have receded from the Milky Way, thereby maintaining forever the present appearance of the universe. In order to produce the matter, a reservoir of energy would be required. In order to prevent this reservoir being diluted, by the creation of matter and by the expansion of the universe, he made this reservoir negative. The expansion and creation now work against each other and a steady state of energy is maintained.
from hXXp://wXw.schoolsobservatory.org.uk/study/sci/cosmo/internal/steady.htm[excerpt from “Steady-state Theory,” Wikipedia]

The steady state theory of Bondi, Gold and Hoyle was inspired by the circular plot of the film Dead of Night they watched together[1]. Further theoretical calculations that showed that a static universe was impossible under general relativity and observations by Edwin Hubble that the universe was expanding. The steady state theory asserts that although the universe is expanding, it nevertheless does not change its look over time (the perfect cosmological principle); it has no beginning and no end.

The steady state theory requires that new matter must be continuously created (mostly as hydrogen) to keep the average density of matter equal over time. The amount required is low and not directly detectable: roughly one solar mass of baryons per cubic megaparsec per year or roughly one hydrogen atom per cubic meter per billion years, with roughly five times as much dark matter. Such a creation rate would, however, cause observable effects on cosmological scales.

An aesthetically unattractive feature of the theory is that the postulated spontaneous new matter formation would presumably need to include deuterium, helium, and a small amount of lithium, as well as regular hydrogen, since no mechanism of nucleosynthesis in stars or by other processes accounts for the observed abundance of deuterium and helium-3. [In the Big Bang model, primordial deuterium is made directly after the “bang,” before the existence of the first stars].

Chaotic inflation theory has many similarities with steady state theory, although on a much larger scale than originally envisaged.

### [Edit] Problems

Problems with the steady-state theory began to emerge in the late 1960s, when observations apparently supported the idea that the universe was in fact changing: quasars and radio galaxies were found only at large distances (i.e., redshift, and thus, because of the finiteness of the speed of light, in the past) not in closer galaxies. Halton Arp, also since the 1960s, has been taking a different view of the data, claiming that evidence can also point to quasars existing as close as the local Virgo cluster, however, this theory is not accepted by mainstream scientists today.

For most cosmologists, the refutation of the steady-state theory came with the discovery of the cosmic background radiation in 1965, which was predicted by the big bang theory. Stephen Hawking said that the fact that microwave radiation had been found, and that it was thought to be left over from the big bang, was “the final nail in the coffin of the steady-state theory.” Within the steady state theory this background radiation is the result of light from ancient stars which has been scattered by galactic dust. However, this explanation has been unconvincing to most cosmologists as the cosmic microwave background is very smooth, making it difficult to explain how it arose from point sources, and the microwave background shows no evidence of features such as polarization which are normally associated with scattering. Furthermore, its spectrum is so close to that of an ideal black body that it could hardly be formed by the superposition of contributions from dust clumps at different temperatures as well as at different redshifts. Steven Weinberg wrote in 1972,

The steady state model does not appear to agree with the observed dL versus z relation or with source counts . . . In a sense, the disagreement is a credit to the model; alone among all cosmologies, the steady state model makes such definite predictions that it can be disproved even with the limited observational evidence at our disposal. The steady-state model is so attractive that many of its adherents still retain hope that the evidence against it will disappear as observations improve. However, if the cosmic microwave background radiation . . . is really black-body radiation, it will be difficult to doubt that the universe has evolved from a hotter, denser early stage.

As of 2006, the majority of astronomers consider the big bang theory to be the best description of the origin of the universe. In most astrophysical publications, the big bang is implicitly accepted and is used as the basis of more complete theories. Attempts incorporate the cosmic microwave background or the latest measurements of dark energy have lead to the development of quasi-steady state theories.

### [Edit] C-Field

Bondi and Gold proposed no mechanism for the creation of matter required by the steady state theory, but Hoyle proposed the existence of what he called the “C-field”, where “C” stands for “Creation”. The C-field has negative pressure, creates the matter, and drives the steady expansion of the cosmos. These properties are all shared by the inflaton field used in cosmic inflation. In this fashion Hoyle's conception of the steady state in 1948 incorporates many features that later emerged in inflationary cosmology, especially in chaotic inflation theory or eternal inflation which sometimes posits an infinite universe with neither beginning nor end in which inflation operates continuously, on a scale beyond the observable universe, to create the matter of the cosmos.
Wikipedia, “Steady-state Theory” (as of Jan. 24, 2007)

Appendix content ends here.

What is claimed is:

1. A method for a user to explore relationships between data in a plurality of pages, the method comprising:
(a) choosing a current page from among the plurality of pages;
(b) determining one or more connections, each representing an instance of one of the relationships, wherein each said connection has at least one departure location in a said page and at least one arrival location in a said page;
(c) with respect to said current page, choosing a current connection from among said one or more connections;
(d) choosing a current departure location of said current connection;
(e) choosing a current arrival location of said current connection;
(f) spatially isolated in a display, presenting at least a portion of said page that includes said current departure location as a first page segment, presenting at least a portion of said page that includes said current arrival location as a second page segment, and presenting said current departure location said current arrival location as visually connected;
(g) accepting a user selection of a said content link in said display to be a selected link, wherein said selected link accordingly has a selected departure location and a selected arrival location, and responsive thereto, making said selected departure location a new current arrival location and said selected arrival location a new current departure location and performing (f), thereby step-wise navigate ably presenting said pages to swing the user's focus to said current departure location along with its relationship to said current arrival location.
